(19) United States
(12) Patent Application Publication
(10) Pub. No.: US 2023/0088643 A1
(43) Pub. Date: Mar. 23, 2023

(54) DISTRIBUTED QUANTUM COMPUTING SYSTEM

(71) Applicant: Optum Services (Ireland) Limited, Dublin 1 (IE)

(72) Inventors: Vicente Rubén Del Pino Ruiz, Dublin (IE); Paul J. Godden, London (GB); Tomasz Krol, Dublin (IE)

(21) Appl. No.: 17/645,122

(22) Filed: Dec. 20, 2021

Related U.S. Application Data
(60) Provisional application No. 63/246,302, filed on Sep. 20, 2021.

(51) Int. Cl. G06N 10/60; G06N 10/80; G06N 10/20; G06F 16/27

(52) U.S. Cl. CPC G06N 10/60; G06N 10/80; G06N 10/20; G06F 16/27

(57) ABSTRACT

A method for executing a query, the method comprising: obtaining, by a central node, a data request, wherein a first operational node stores a first dataset and the data request indicates that the first operational node needs a second dataset to finish an operation that involves generating a joined dataset based on the first dataset and the second data; and based on the data request, sending, by the central node, a data load request to a second operational node, wherein: the second operational node stores the second dataset, a first entangled qubit set at the first operational node includes qubits that are entangled with qubits in a second entangled qubit set at the second operational node, and the data load request instructs the second operational node to use the second entangled qubit set to transfer a quantum state based on the second dataset to the first entangled qubit set.

This application claims the benefit of U.S. Provisional Application Ser. No. 63/246,302, filed Sep. 20, 2021, the entire content of which is incorporated herein by reference.

### TECHNICAL FIELD

The disclosure relates to quantum computing.

### BACKGROUND

In contrast to classical computing, which is based on classical physics, quantum computing leverages quantum mechanics to process information. Specifically, quantum computers may perform computational tasks by executing quantum algorithms (e.g., quantum logic operations applied to quantum bits (“qubits”)). A quantum algorithm may represent a quantum circuit that includes one or more quantum gates configured to act on qubits. By applying quantum gates in succession, a quantum computer may perform a transformation to a set of qubits that are in some initial state.

Due to the laws of quantum mechanics, qubits are not binary in nature. For example, a qubit may exist as 0, 1, or simultaneously as both 0 and 1, with a numerical coefficient representing a probability for each state. This superposition of states may enable computational leaps over classical computing techniques. A variety of physical systems have been developed for quantum computing applications. Examples include superconducting circuits, trapped ions, spin systems, and others.

### SUMMARY

Various industries, such as healthcare, may require usage of large datasets for research and other purposes. Such datasets may demand significant computational and storage resources, particularly for consideration of multiple cohorts sufficient for comparative analyses across typical case-control studies. For example, in the context of genomics, searching through a repository for particular variants can be a computationally challenging task, as can be variant annotation and integrating these data in a multi-omics scenario. As a result, performing such operations using a distributed system based on classical computing may be expensive and time-consuming (e.g., due to the need to transmit large volumes of data between nodes of the distributed system).

This disclosure describes a distributed system based on quantum computing to improve distributed systems operations, such as moving data and duplication of effort in data processing. Additionally, the system improves the performance of searching and finding information in datasets to facilitate the joining of datasets, which may lead to key improvements in, for example, the creation of multi-omics cohorts where multiple varieties of genomics data (e.g., methylation, deoxyribonucleic acid (DNA) sequences, small conditional ribonucleic acid (scRNA), etc.) are present for joint analyses.

Thus, this disclosure describes techniques for data transfer. A first node of a distributed quantum computing system sends a request for a dataset to a quantum central system of the distributed quantum computing system. The quantum central system sends the request for the dataset to a second node, where the dataset is stored at the second node. A quantum framework associated with the second node executes a quantum algorithm to transform a state of an entangled set of qubits at the second node. Transformation of the state of the entangled set of qubits at the second node effectuates a corresponding transformation of an entangled set of qubits at the first node that provides an indication of the dataset. A quantum framework associated with the first node processes the transformed entangled set of qubits at the first node to obtain the dataset.

In one example, a method includes: generating at least one entangled set of qubits for each node of a plurality of nodes of a distributed quantum computing system; mapping entanglements between each of the entangled sets of qubits; and storing the mapping of the entanglements in a repository of the distributed quantum computing system.

In one example, a method includes: sending, by a first node of a distributed quantum computing system, a request for a dataset to a quantum central system of the distributed quantum computing system; sending, by the quantum central system, the request for the dataset to a second node, wherein the dataset is stored at the second node; executing, by a quantum framework associated with the second node, a quantum algorithm to transform a state of an entangled set of qubits at the second node, wherein transformation of the state of the entangled set of qubits at the second node effectuates a corresponding transformation of an entangled set of qubits at the first node that provides an indication of the dataset; and processing, by a quantum framework associated with the first node, the transformed entangled set of qubits at the first node to obtain the dataset.

In one example, a method includes: initiating, by a first node of a distributed quantum computing system, a process to join a first dataset with a second dataset, wherein the first dataset is stored at the first node, and wherein the second dataset is stored at a second node of the distributed quantum computing system; processing, by a quantum framework associated with a first node of a distributed quantum computing system, an entangled set of qubits at the first node to obtain the second dataset from the second node; and joining, by the quantum framework, the first dataset with the second dataset by searching for identifying information in the first dataset that corresponds with identifying information in the second dataset.

In one example, this disclosure describes a method for executing a query on a distributed database stored at plurality of operational nodes of a distributed computing system, the method comprising: obtaining, by a central node of the distributed computing system, a data request, wherein a first operational node of the distributed computing system stores a first dataset and the data request indicates that the first operational node needs a second dataset to finish an operation that involves generating a joined dataset based on the first dataset and the second data; and based on the data request, sending, by the central node, a data load request to a second operational node of the plurality of operational nodes, wherein: the second operational node stores the second dataset, a first entangled qubit set at the first operational node includes qubits that are entangled with qubits in a second entangled qubit set at the second operational node, and the data load request instructs the second operational node to use the second entangled qubit set to transfer a quantum state based on the second dataset to the first entangled qubit set.

In another example, this disclosure describes a method comprising: storing, by a first operational node of a distributed computing system that includes a plurality of operational nodes, a first dataset, wherein the first operational node has a first entangled qubit set; and as part of the distributed computing system executing a query on a distributed database stored at the plurality of operational nodes: obtaining, by the first operational node, a transfer notification indicating that a second operational node of the distributed computing system has loaded a second dataset into a second entangled qubit set, wherein the second entangled qubit set includes qubits that are entangled with qubits of the first entangled qubit set; after obtaining the transfer notification, performing, by the first operational node, a join operation on the first dataset and the second dataset to generate a joined dataset.

In another example, this disclosure describes a distributed computing system comprising: a plurality of operational nodes configured to store a distributed database, the plurality of operational nodes including at least a first operational node and a second operational node, wherein: the first operational node comprises: one or more first storage devices configured to store a first dataset; and a first entangled qubit set, and the second operational node comprises: one or more second storage devices configured to store a second dataset; and a second entangled qubit set, wherein the second entangled qubit set includes qubits entangled with qubits of the first qubit set; and a central node comprising one or more processors implemented in circuitry, the one or more processors of the central node configured to send a data load request to the second operational node, the data load request instructs the second operational node to use the second entangled qubit set to transfer a quantum state based on the second dataset to the first entangled qubit set, wherein: the second operational node is configured to, based on the data load request: use the second entangled qubit set to transfer the quantum state based on the second dataset to the first entangled qubit set; and transmit a transfer notification, and the first operational node is configured to: based on obtaining the transfer notification, perform a join operation on the first dataset and the second dataset to generate a joined dataset.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a block diagram of an example architecture of a traditional distributed computing system.

FIG. 2 is a block diagram of an example of shuffling and broadcasting in a distributed computing system.

FIG. 3 is a conceptual diagram illustrating an example query plan.

FIG. 4 is a block diagram illustrating a distributed computing system in accordance with one or more techniques of this disclosure.

FIG. 5 is a block diagram illustrating an example operational node of the distributed computing system in accordance with one or more techniques of this disclosure.

FIG. 6 is a block diagram illustrating example components of a central node of the distributed computing system in accordance with one or more techniques of this disclosure.

FIG. 7 is a flowchart of an example operation for generating entangled sets of qubits by the distributed computing system in accordance with one or more techniques of this disclosure.

FIG. 8 is a flowchart of an example operation for moving datasets between operational nodes of the distributed computing system in accordance with one or more techniques of this disclosure.

FIG. 9 is a flowchart of an example operation for joining datasets by the distributed computing system in accordance with one or more techniques of this disclosure.

FIG. 10 is a flowchart illustrating an example operation of a central node of a distributed computing system in accordance with one or more techniques of this disclosure.

FIG. 11 is a flowchart illustrating an example operation of an operational node of the distributed computing system in accordance with one or more techniques of this disclosure.

### DETAILED DESCRIPTION

A distributed computing system may include many operational nodes that are configured to store data of a distributed database. The use of a distributed database may allow the distributed computing system to store more data than would be possible on a single node. However, executing queries on the distributed database may involve copying datasets from one operational node to another operational node. For example, when execution of a query involves performing a join operation that involves generating joined data based on a first dataset stored at a first operational node and a second dataset stored at a second operational node, the second dataset may be copied from the second operational node to the first operational node. The movement of such datasets may be time and resource intensive, especially for when the datasets are very large.

In accordance with one or more techniques of this disclosure, a distributed quantum computing system may improve distributed systems operations, such as moving data and performing join operations. This disclosure may also refer to the distributed quantum computing system simply as a distributed computing system. In some examples, the distributed computing system may improve searching for information in datasets to facilitate the joining of datasets. The ability to efficiently process queries on distributed databases may lead to advancements in, for example, the creation of multi-omics cohorts where multiple varieties of genomics data (e.g., methylation, DNA sequence scRNA, etc.) are present for joint analyses. For instance, the ability to perform join operations on separate datasets may have significant consequences for certain aspects of genomics research such as the detection of orthologous genes where there are a number of candidate sequences remains a computationally intensive problem.

As mentioned above, working with large datasets, such as datasets used in big data processes, is a challenge because there may be an exponential grow of datasets available to research. This problem may be especially acute with respect to healthcare. For example, in genomics, a simple record for a single patient may take up to several gigabytes (GBs) of information. Typical file sizes for a complete human genome are dependent upon the exact type of assay being performed. For a 30× coverage whole genome sequence (WGS), a FASTQ file could be 2*3×10⁹*30≈100 GB in size. For consideration of multiple cohorts of patients sufficient for comparative analyses across typical case-control studies, the total file size would be several thousand times this estimate. Variant Call Format (VCF) files generated in a typical human variant calling scenario may also be significant: the per-chromosome HG00365 VCFs from the “1,000 Genomes” repository is a total of ≈1.3 GB—though searching through a large repository for particular variants can also a computationally-challenging task, as is variant annotation and integrating these data in a multi-omics scenario.

In another example, databases may store large-scale multi-omics repositories. Multi-omics repositories may store clinical, DNA variant, transcriptome, methylation, proteomics and various other types of associated data for individual patients. For instance, the UK BioBank stores multi-omics data for around 500,000 patients in a repository that has multiple different types of image study data, as well as increasing numbers of whole-genome and whole-exome sequences. The techniques of this disclosure may be applicable to such large-scale data repositories.

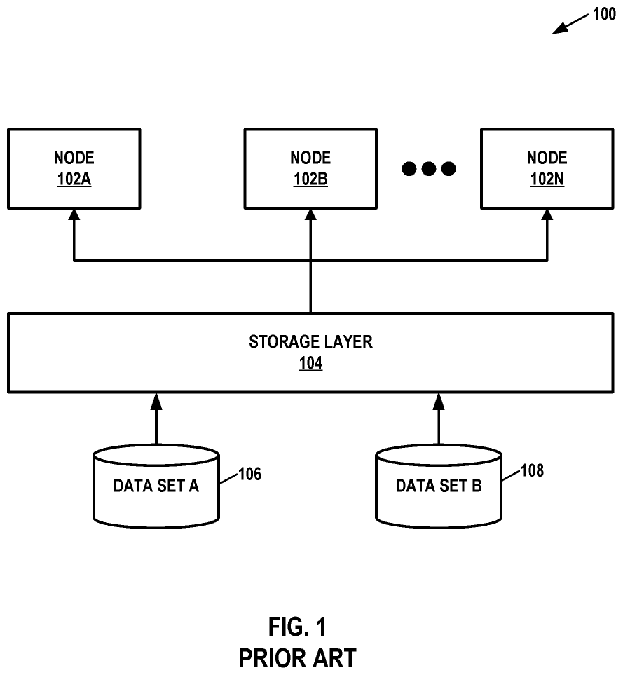

Traditional relational databases may struggle to handle this volume of data and the common approach in industry is to migrate analytics platforms to distributed computing systems like Hadoop, S3, Azure Blob Storage where data is distributed among the operational nodes used for the computing system. FIG. 1 is a block diagram of an example architecture of a traditional distributed computing system 100. In the example of FIG. 1, distributed computing system 100 includes a set of nodes 102A, 102B, through 102N (collectively, “nodes 102”). Nodes 102 may include various types of classical computing devices, such as server computers, personal computers, dedicated data storage devices, and so on. In this disclosure, a classical computing device is a computing device that does not rely on the principles of quantum computing. In the example of FIG. 1, a storage layer 104 of distributed computing system 100 may store datasets (e.g., dataset A 106, dataset B 108) to nodes 102. For example, storage layer 104 may store dataset A to node 102A and may store dataset B to node 102B.

The approach for storing data illustrated with respect to FIG. 1 is associated with challenges in processing and joining different datasets. In the context of healthcare, and multi-omics, joining different dataset may enrich information about a population. Joining different datasets may involve redistribution of datasets (e.g., moving data blocks). Duplication, shuffling, and broadcasting are common approaches for processing big datasets in distributed computing systems.

The duplication approach involves duplicating the same dataset across all the nodes of the distributed computing system. This may help when joining different datasets as a segment to join in both datasets is already stored in the same node. As a trade-off, Extract-Transform-Load (ETL) processes may be penalized in the duplication approach because the ETL processes may have to repeat insert/update operations across multiple nodes for the same data.

The shuffling approach is typically used when datasets are aggregated or joined to each other. In the shuffling approach, all data with the same key should reside in the same data block, so these operations can be carried out effectively. To achieve proper distribution of data, the shuffling approach may require data movement between nodes in the distributed computing system (e.g., nodes within a data center). Data movement between nodes in the distributed computing system may be very expensive because data movement between nodes may require substantial amounts of resources like memory and storage.

The broadcasting approach involves sending a smaller dataset to the nodes where the bigger datasets are stored. This is a type of shuffling in which only one of the datasets (the smaller one) is sent across the distributed computing system. The smaller dataset is stored in memory and never in disk. This operation is an improvement of shuffling, but this operation may still face the same challenges. The main challenge is the availability of memory space, which is currently an expensive resource in data centers.

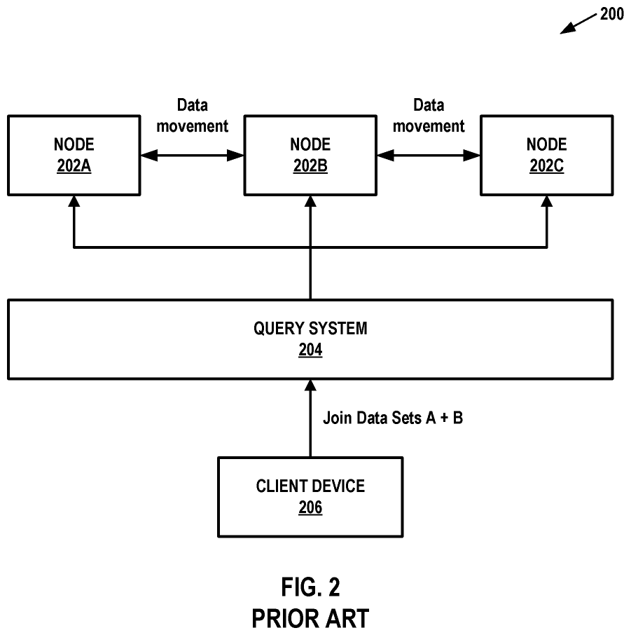

FIG. 2 is a block diagram of an example of shuffling and broadcasting in distributed computing system 200. In the example of FIG. 2, distributed computing system 200 includes nodes 202A, 202B, 202C (collectively, “nodes 202”) and a query system 204. Nodes 202 may store datasets of a distributed database. Query system 204 may include one or more computing devices configured to process queries on the distributed database. In the example of FIG. 2, a client device 206 sends a query to query system 204. Execution of the query involves joining a dataset A and a dataset B. As further shown in the example of FIG. 2, joining dataset A and database B may involve data movement between two or more of nodes 202. As discussed above, such data movement may be expensive.

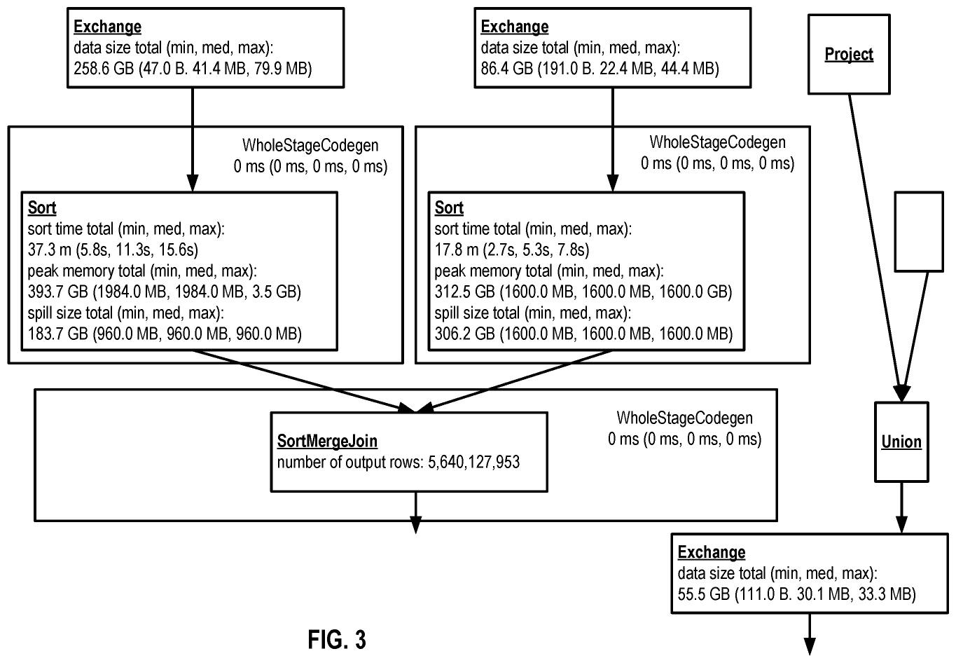

The costs related to the shuffling approach are illustrated in the following example. In this example, typical join and aggregation operations are executed on patient claims data. For instance, the following SQL Query may be performed: select a.col, count(*) from a join b on a.id=b.id join c c on a.id=c.id group by a.col). In this example, tables a, b and c may have sizes of 800 GB, 400 GB, and 200 GB, respectively. FIG. 3 is a conceptual diagram illustrating an example query plan 300. Query plan 300 may be generated by an analytical tool, such as Apache Spark. In the example of FIG. 3, the exchange and sort blocks present a size of the data which have to be shuffled between workers/nodes used in that operation. As can be seen in FIG. 3, 258 GB, 86.4 GB and 55 GB, respectively have to be moved for each table to perform above operations. Each shuffle operation took respectively: 9, 4, and 4 minutes when performed on large server cluster with 200 CPUs and 1.3 TB of RAM. The amount of time required for shuffle operations may significantly change with less compute or more complex operations.

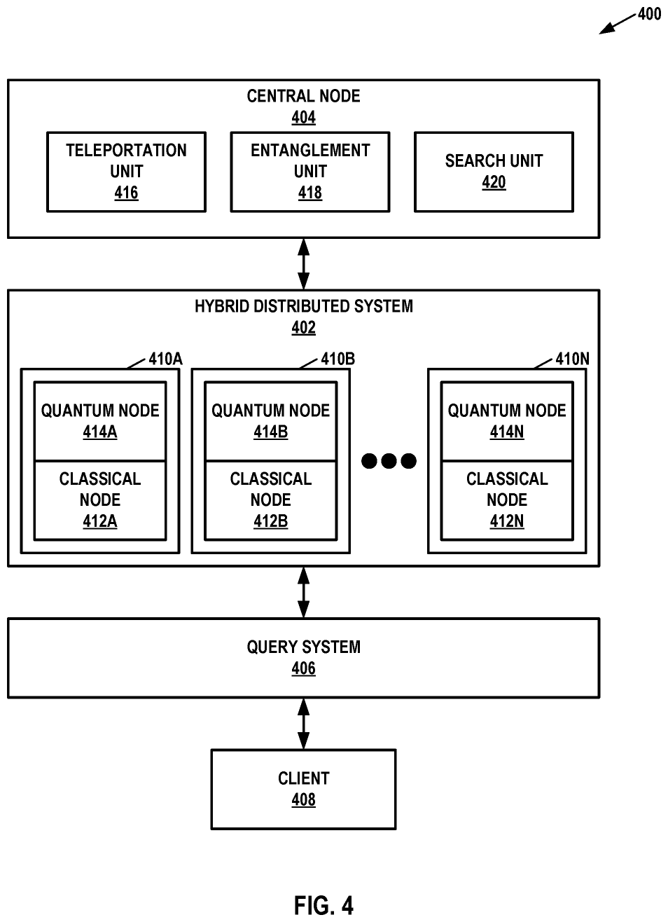

FIG. 4 is a conceptual diagram illustrating an architecture of a distributed computing system 400 in accordance with one or more techniques of this disclosure. Techniques implemented on distributed computing system 400 may address one or more of the issues described above. In some examples, distributed computing system 400 may include a hybrid distributed system 402. Thus, distributed computing system 400 includes classical computing components and quantum computing components. Distributed computing system 400 also includes a central node 404 and a query system 406. In the example of FIG. 4, query system 406 may interact with a client 408.

In the example of FIG. 4, hybrid distributed system 402 includes operational nodes 410A, 410B, through 410N (collectively, “operational nodes 410”). Operational nodes 410 may be geographically distributed. For instance, two or more of operational nodes 410 may be in different cities or countries. In some examples, two or more of operational nodes 410 may be in relatively close proximity to each other. For instance, two or more of operational nodes 410 may be within the same data center.

Operational nodes 410 represents computing systems that may be based at least in part on classical computing. Thus, as shown in the example of FIG. 4, operational nodes 410 may include classical nodes 412A, 412B, through 412N, respectively. This disclosure may refer to classical nodes 412A, 412B, through 412N as “classical nodes 412.” Classical nodes 412 may comprise various types of classical computing devices, such as personal computers, server computers, mobile computers, and other types of devices that do not incorporate quantum computing.

As further shown in FIG. 4, each of operational nodes 410 is associated with a quantum node 414A, 414B, through 414N, respectively. This disclosure may refer to quantum nodes 414A, 414B, through 414N collectively as “quantum nodes 414”. This disclosure may also refer to quantum nodes 414 as “quantum frameworks” or “QFrameworks.” In some examples, the classical node and quantum node of an operational node may be implemented on the same physical device or different physical devices.

Quantum nodes 414 may be configured to perform quantum computing operations for operational nodes 410 of distributed computing system 400. For example, quantum nodes 414 may handle communications across the distributed system between nodes of distributed computing system 400. Quantum nodes 414 may represent an abstraction layer replacing the data communication and movement across distributed computing system 400 based on classical computing. In this way, quantum nodes 414 may ensure that each node receives and sends the data that the node needs to process queries requested by a query layer (e.g., an interface for processing requests for datasets) of the distributed system.

In general, classical nodes 412 may be responsible for managing a query layer and a storage layer (e.g., an interface for coordinating storage of datasets). In examples where distributed computing system 400 includes classical computing components, the classical computing components may be implemented using techniques known in the art. The query layers of classical nodes 412 are configured to process queries. The storage layers of classical nodes 412 are configured to store datasets of a distributed database. The distributed database may be structured in one of a variety of ways. For example, the distributed database may be a data lake, a relational database, a file system, an object-oriented database, or other collections of data. In some examples, one or more of operational nodes 410 may include two or more quantum nodes. In some examples, datasets of the distributed database may be stored in classical nodes that are not associated with quantum nodes, in which case data may be transferred via classical communication.

Client 408 may be a device that uses query results generated by distributed computing system 400. Client 408 may be a personal computer, server computer, mobile device, or other type of computing device. In some examples, client 408 is separate from any of the devices of distributed computing system 400. In other examples, client 408 is included is or is included in one of the devices of distributed computing system 400.

Query system 406 may act as an interface between distributed computing system 400 and client 408. For example, query system 406 may provide query results to client 408. In some examples, query system 406 may receive requests from client 408 to execute queries. Query system 406 may also provide instructions to individual operational nodes 410 to perform all or parts of executing a query. Query system 406 may include one or more computing devices. In the example of FIG. 4, query system 406 is shown as being separate from central node 404 and operational nodes 410. However, in other examples, central node 404 or one or more of operational nodes 410 performs the functionality of query system 406.

To improve the movement of data between operational nodes 410 of distributed computing system 400, distributed computing system 400 relies on the principle of quantum entanglement (e.g., a quantum mechanical phenomenon in which the quantum states of two or more objects may be described with reference to each other, even though the individual objects may be spatially separated, leading to correlations between observable physical properties of the systems). Sets of qubits, which represent a basic unit of quantum information, may be entangled, and the entangled sets of qubits may be physically transported to various nodes of the system. Because of quantum entanglement, a transformation of a state of the entangled set of qubits at one quantum node of distributed computing system 400 may, in effect, effectuate (essentially instantaneously) a corresponding transformation of an entangled set of qubits at one or more other quantum nodes of distributed computing system 400.

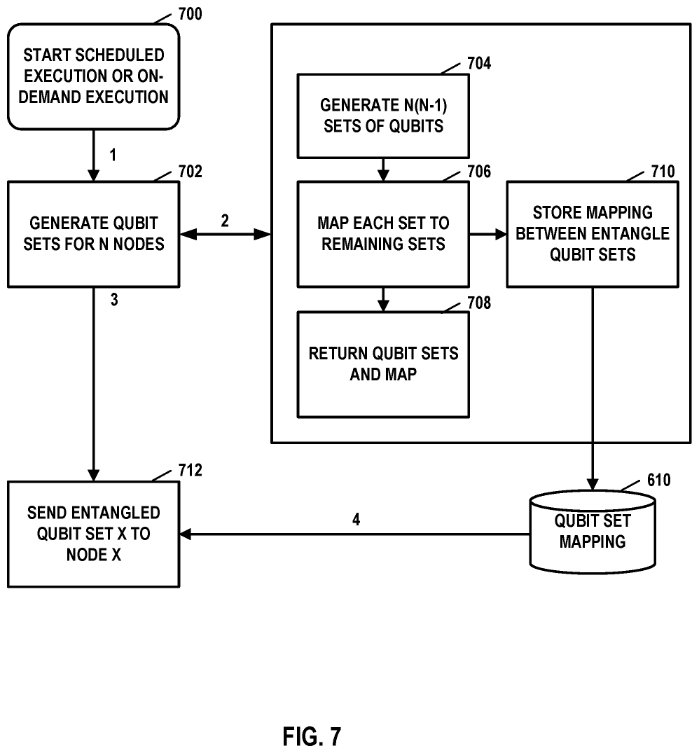

Central node 404 may include a teleportation unit 416, an entanglement unit 418, and a search unit 420. In some examples, teleportation unit 416, entanglement unit 418, and search unit 420 correspond to distinct physical hardware or software structures. In some examples, teleportation unit 416, entanglement unit 418, and search unit 420 may be implemented by common hardware. Entanglement unit 418 may initialize hybrid distributed system 402 with entangled qubits. An example process for initializing hybrid distributed system 402 with entangled qubits is described below with respect to FIG. 7. Furthermore, when distributed computing system 400 is executing a query, such as a query that involves a join operation, a first operational node (i.e., a receiving operational node) of operational nodes 410 may need to receive a non-local dataset (i.e., a dataset that is not stored at the operational node) from another operational node of distributed computing system 400. In accordance with one or more techniques of this disclosure, the classical node of the receiving operational node may send a data request to central node 404. The data request may request the non-local dataset. Based on obtaining to the data request, search unit 420 of central node 404 may send a data load request to a second operational node (i.e., a sending operational node). The data load request may identify the non-local dataset. For instance, the data load request may include a Uniform Resource Locator (URL) or table name of the non-local dataset. In some examples, the data load request may include a sub-query and the second operational node may generate the non-local dataset based on two or more datasets stored (or retrieved by) the second operational node. Teleportation unit 416 may perform the actions of central node 404 to facilitate quantum teleportation. Search unit 420 may determine which operational nodes store the datasets indicated by the data requests.

Based on the data load request, the quantum node of the sending operational node (i.e., the sending quantum node) may load the non-local dataset into a staging qubit set of the sending quantum node. Loading a dataset into a qubit set may involve generating a superposition of quantum states of qubits of the qubit set. Amplitude encoding is one example technique for generating the superposition of quantum states. The sending quantum node may then use quantum teleportation to transfer a quantum state of the staging qubit set to an entangled qubit set at a quantum node of the receiving operational node (i.e., the receiving quantum node) via a quantum communication channel. That is, the receiving quantum node has a first entangled qubit set and the sending quantum node has a second entangled qubit set. The second entangled qubit set includes qubits that are entangled with qubits of the first entangled qubit set. When using quantum teleportation, the sending quantum node modifies the second entangled qubit set based on the quantum state of the staging qubit set. The sending quantum node then measures the staging qubit set and the second entangled qubit set. Additionally, the sending quantum node generates a transfer notification based on the measurements of the staging qubit set and the second entangled qubit set. The classical node of the sending operational node (i.e., the sending classical node) may send the transfer notification via a classical communication channel to central node 404 for forwarding to the classical node of the receiving operational node (i.e., the receiving classical node). In some examples, the sending classical node sends the transfer notification directly to the receiving classical node via a classical communication channel. The receiving quantum node may modify the quantum state of the first entangled qubit set based on the data in the transfer notification. As a result of this process, the quantum state of the staging qubit set is transferred to the first entangled qubit set.

The receiving operational node may perform various actions after the quantum state of the staging qubit set is transferred to the first entangled qubit set. For example, the first quantum node may measure the qubits of the first entangled qubit set. In another example, the receiving quantum node may perform a quantum search algorithm on the first entangled qubit set without first measuring the first entangled qubit set. For example, the receiving quantum node may perform one or more iterations of Grover's algorithm to identify one or more entries (e.g., database rows) of the second dataset. The identified entries of the second dataset may have the same index values as entries in the first dataset (or index values derived from index values of the first dataset), i.e., associated entries of the first dataset. The receiving operational node may generate a table that includes data based on the identified nodes of the second dataset and data based on the associated entries of the first data. Data based on an entry may be a copy of some or all data in the entry or data that is a result of applying one or more functions to data in the entry. For example, the second dataset may include entries corresponding to genomes of a patient cohort. In this example, the local operational node may store a nucleotide sequence and a dataset stored at the local operational node contains patient contact information. In this example, the receiving operational node may perform a join operation to generate a joined table having entries that contain the contact information of each patient that has a genome that includes the target nucleotide sequence and indexes of the entries in the second dataset for the patients. Accordingly, in this example, the receiving quantum node may perform Grover's algorithm to find entries (e.g., database rows) in the second dataset that contain the nucleotide sequence. Obtaining the genomes based on the indexes in the joined table may involve communicating the genomes via a classical communication channel. Thus, in this example, neither the nucleotide sequence nor the second dataset needs to be communicated to another node via a classical communication channel in order for the receiving operational node to generate the joined table.

Thus, in the example of FIG. 4, distributed computing system 400 may include a plurality of operational nodes 410 configured to store a distributed database. The plurality of operational nodes 410 include at least a first operational node and a second operational node. The first operational node comprises one or more first storage devices configured to store a first dataset and a first entangled qubit set. The second operational node comprises one or more second storage devices configured to store a second dataset. The second operational node also comprises a second entangled qubit set. The second entangled qubit set includes qubits entangled with qubits of the first qubit set. Distributed computing system 400 may also include central node 404 comprising one or more processors implemented in circuitry. The one or more processors of central node 404 may be configured to send a data load request to the second operational node. The data load request may instruct the second operational node to use the second entangled qubit set to transfer a quantum state based on the second dataset to the first entangled qubit set. The second operational node may be configured to, based on the data load request, use the second entangled qubit set to transfer the quantum state based on the second dataset to the first entangled qubit set. The second operational node may also transmit a transfer notification. The first operational node may be configured to, based on obtaining the transfer notification, perform a join operation on the first dataset and the second dataset to generate a joined dataset. For instance, the first operational node may, as part of performing the join operation, perform a quantum search operation using the first entangled qubit set to identify data in the second dataset.

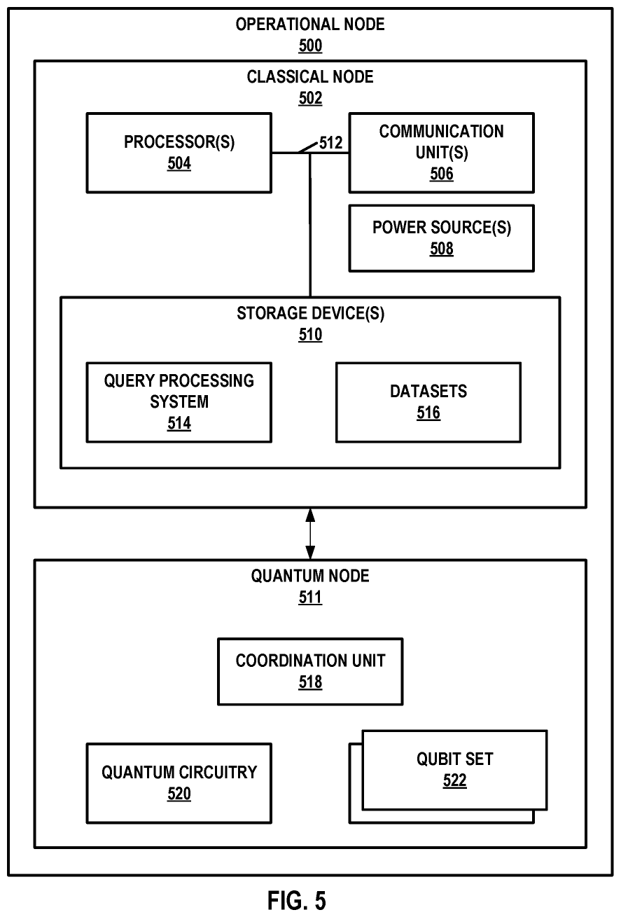

FIG. 5 is a block diagram illustrating an example operational node 500 of distributed computing system 400 in accordance with one or more techniques of this disclosure. Operational node 500 may be one of operational nodes 410 (FIG. 4). FIG. 5 illustrates only one example of operational node 500, without limitation on any other example configurations of distributed computing system 400, and may comprise a separate system of one or more computing devices.

As shown in the example of FIG. 5, operational node 500 includes a classical node 502 and a quantum 511. Classical node 502 includes one or more processors 504, one or more communication units 506, one or more power sources 508, one or more storage devices 510, and one or more communication channels 512. Classical node 502 may include other components. For example, classical node 502 may include input devices, output devices, display screens, and so on. Communication channel(s) 512 may interconnect each of processor(s) 504, communication unit(s) 506, and storage device(s) 510 for inter-component communications (physically, communicatively, and/or operatively). In some examples, communication channel(s) 512 may include a system bus, a network connection, an inter-process communication data structure, or any other method for communicating data. Power source(s) 508 may provide electrical energy to processor(s) 504, communication unit(s) 506, storage device(s) 510 and communication channel(s) 512. Storage device(s) 510 may store information required for use during operation of operational node 500.

Processor(s) 504 comprise circuitry configured to perform processing functions. For instance, one or more of processor(s) 504 may be a microprocessor, an application-specific integrated circuit (ASIC), a field-programmable gate array (FPGA), or another type of processing circuitry. In some examples, processor(s) 504 of classical node 502 may read and execute instructions stored by storage device(s) 510. Processor(s) 504 may include fixed-function processors and/or programmable processors. Processor(s) 504 may be included in a single device or distributed among multiple devices.

Communication unit(s) 506 may enable operational node 500 to send data to and receive data from one or more other computing devices (e.g., via a classical (i.e., non-quantum) communications network, such as a local area network or the Internet). In some examples, communication unit(s) 506 may include wireless transmitters and receivers that enable operational node 500 to communicate wirelessly with other computing devices. Examples of communication unit(s) 506 may include network interface cards, Ethernet cards, optical transceivers, radio frequency transceivers, or other types of devices that are able to send and receive information. Other examples of such communication units may include BLUETOOTH™, 3G, 4G, 5G, and WI-FI™ radios, Universal Serial Bus (USB) interfaces, etc. Operational node 500 may use communication unit(s) 506 to communicate with one or more other computing devices or systems, such as central node 404, query system 406, and/or other operational nodes 410. Communication unit(s) 506 may be included in a single device or distributed among multiple devices.

Processor(s) 504 may read instructions from storage device(s) 510 and may execute instructions stored by storage device(s) 510. Execution of the instructions by processor(s) 504 may configure or cause classical node 502 to provide at least some of the functionality ascribed in this disclosure to classical node 502. Storage device(s) 510 may be included in a single device or distributed among multiple devices.

As shown in the example of FIG. 5, storage device(s) 510 may store computer-readable instructions associated a query processing system 514. For ease of explanation, this disclosure may describe actions performed by classical node 502 when processors 504 execute instructions associated with query processing system 514 as being performed by query processing system 514 itself.

Storage device(s) 510 may also store one or more datasets 516. A dataset may be any set of data. In some examples, a dataset includes a table of a relational data. In some examples, a dataset is one or more binary large objects (BLOB s). Datasets 516 may include various types of data. For example, datasets 516 may include multi-omics data, clinical data, scientific data, economic data, and so on.

Query processing system 514 is configured to process query-related activities of classical node 502. For instance, as described in greater detail elsewhere in this disclosure, query processing system 514 may receive a query, e.g., from query system 406. In examples where query processing system 514 is able to execute the query using only datasets 516 stored in storage device(s) 510 of operational node 500, query processing system 514 may use datasets 516 to execute the query without involvement of quantum 511. In other examples, execution of the query may involve non-local datasets (e.g., datasets that are not stored in storage device(s) 510 of operational node 500. In some examples, when the size of non-local datasets is below a size threshold, query processing system 514 may request and receive the datasets via a classical communication network. However, in other examples, such as examples where the size of the non-local datasets is above the size threshold, query processing system 514 may use quantum 511 to obtain the non-local datasets.

In the example of FIG. 5, quantum 511 includes a coordination unit 518, quantum circuitry 520, and one or more qubit sets 522. In general, coordination unit 518 may be configured to coordinate activities of quantum 511. For instance, coordination unit 518 may coordinate obtaining non-local datasets. In some examples, coordination unit 518 may also coordinate execution of quantum algorithms. Quantum circuitry 520 is configured to perform quantum algorithms using qubit sets 522. For example, quantum circuitry 520 may be configured to perform a quantum search algorithm, such as Grover's algorithm. Qubit sets 522 are sets of qubits. Qubit sets 522 may include qubits that are entangled with qubits at other operational nodes of distributed computing system 400. In some examples, qubit sets 522 may include qubits that are not entangled with other qubits. This disclosure may refer to qubits that are not entangled with other qubits as temporal qubits.

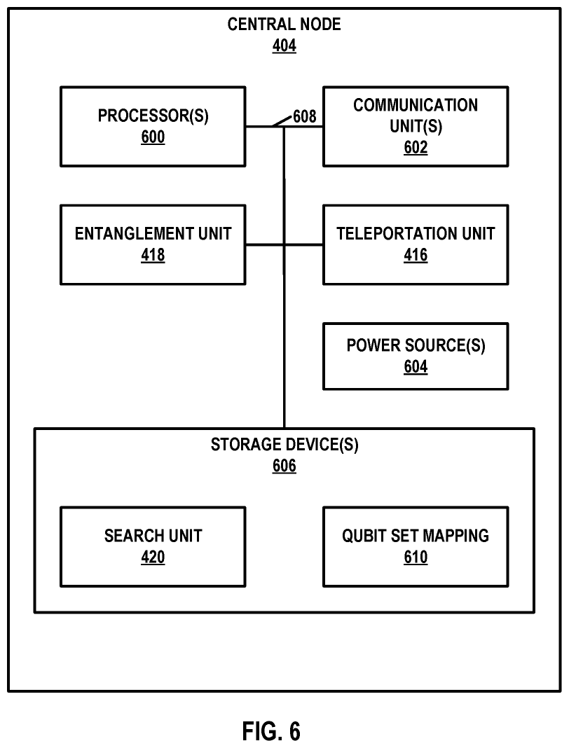

FIG. 6 is a block diagram illustrating example components of central node 404 of the distributed computing system in accordance with one or more techniques of this disclosure. In the example of FIG. 6, central node 404 includes teleportation unit 416 and entanglement unit 418, as shown in the example of FIG. 4. Additionally, in the example of FIG. 6, central node 404 includes one or more processors 600, one or more communication units 602, one or more power sources 604, one or more storage devices 606, and one or more communication channels 608. Processor(s) 600, communication unit(s) 602, power source(s) 604, storage device(s) 606, and communication channels 608 may be implemented in the same or similar manner as processor(s) 504, communication unit(s) 506, power source(s) 508, storage device(s) 510, and communication channels 512 of FIG. 5.

Entanglement unit 418 may generate entangled qubit sets. Entanglement unit 418 may generate entangled qubits in one of a variety of ways. For example, entanglement unit 418 may perform spontaneous parametric down-conversion to generate pairs of photons entangled in polarization. In another example, entanglement unit 418 may use a fiber coupler to confine and mix photons. In another example, entanglement unit 418 may use photons emitted from a decay cascade of a bi-exciton in a quantum dot or may use the Hong-Ou-Mandel effect.

Teleportation unit 416 may perform the actions of central node 404 to facilitate quantum teleportation. For example, teleportation unit 416 may receive and forward transfer notifications.

In the example of FIG. 6, storage device(s) 606 of central node 404 include search unit 420 and qubit set mapping 610. Search unit 420 may comprise instructions that are executable by processor(s) 600. In some examples, teleportation unit 416 may also comprise instructions that are executable by processor(s) 600. This disclosure may describe actions performed by processors when executing instructions associated with a unit as being performed by the unit. This disclosure may also refer to qubit set mapping 610 as a qubit set mapping repository.

Search unit 420 may obtain data requests, e.g., from query system 406 or one of operational nodes 410. The data requests may indicate one or more datasets needed by an operational node to complete an operation. For example, a data request may specify a particular BLOB or table of relational data. Search unit 420 may determine which operational nodes store the datasets indicated by the data requests. For example, search unit 420 may use an index to look up which operational nodes store the datasets indicated by the data requests.

Additionally, search unit 420 may use qubit set mapping 610 to obtain identifiers of entangled qubit sets. Entanglement unit 418 may generate pairs of entangled qubit sets for each combination of quantum nodes 414. For example, entanglement unit 418 may generate a pair of entangled qubit sets for quantum node 414A and 414B, a pair of entangled qubit sets for quantum node 414A and 414N, a pair of entangled qubit sets for quantum node 414B and 414N, and so on. In some examples, entanglement unit 418 may be implemented on one of operational nodes 410.

Entanglement unit 418 may assign identifiers (e.g., numeric values, alphanumeric values, etc.) to each entangled qubit set of a pair of entangled qubit sets. Entanglement unit 418 may provide the identifier of an entangled qubit set to a quantum node when entanglement unit 418 sends the entangled qubit set to the quantum node. Additionally, entanglement unit 418 may update qubit set mapping 610 to include an entry that maps the identifiers of the pair of entangled qubit sets to each other. When search unit 420 subsequently receives a data request from a first quantum node that requests a dataset stored at a second operational node, search unit 420 may use qubit set mapping 610 to look up an identifier of an entangled qubit set at the second quantum node (i.e., the quantum node at the second operational node) that is entangled with an entangled qubit set at the first quantum node (i.e., the quantum node of the first operational node). Search unit 420 may then send a data load request to the second quantum node that includes the identifier of the entangled qubit set at the second operational node. In this way, the second quantum node has the information needed to determine which entangled qubit set to use to transfer a quantum state based on the dataset to the first quantum node. In this example, search unit 420 may also send an identifier of the entangled qubit set at the first quantum node (i.e., the first entangled qubit set) to the first quantum node. In this way, the first quantum node has the information needed to determine which of the entangled qubit sets at the first quantum node will receive transfer of the quantum state based on the dataset. In some examples, search unit 420 may also include the identifier of the first entangled qubit set to the second quantum node. In this example, a transfer notification sent to the first quantum node (via teleportation unit 416 or directly from the second quantum node) may include the identifier of the first entangled qubit set.

In other examples, such as examples in which the functionality of search unit 420 and/or teleportation unit 416 are performed on individual operational nodes 410, entanglement unit 418 may generate a first entangled qubit set that is entangled with a second entangled qubit set. Entanglement unit 418 may send the first entangled qubit set to a first quantum node and send the second entangled qubit set to a second quantum node. Entanglement unit 418 may send identifiers of both the first and second entangled qubit sets to the first quantum node. In such examples, the first quantum node may determine locally that the second quantum node has a needed dataset and may send a data request to the second quantum node along with the identifier of the second entangled qubit set. In this way, the second quantum node may have the information needed to determine which entangled qubit set to use to transfer a quantum state based on the dataset to the first quantum node.

FIG. 7 is a flowchart of an example operation for generating entangled sets of qubits by distributed computing system 400 in accordance with one or more techniques of this disclosure. In the example of FIG. 7, entanglement unit 418 may generate entangled qubit sets (i.e., sets of entangled qubits). Entanglement unit 418 may generate entangled qubit sets at a scheduled frequency. For example, entanglement unit 418 may generate entangled qubit sets once per minute, day, etc. In some examples, entanglement unit 418 may generate entangled qubit sets on demand. For instance, entanglement unit 418 may generate entangled qubit sets when triggered by a quantum node (e.g., one of quantum nodes 414) which has run out of entangled qubits. A quantum node may run out of entangled qubits when the quantum node after the quantum node has measured the entangled qubits. Thus, the operation shown in FIG. 7 may be started for a scheduled execution or an on-demand execution (700).

Thus, in some examples where entanglement unit 418 generates entangled qubits on-demand, central node 404 (e.g., entanglement unit 418 of central node 404) may receive a qubit refresh request from a first operational node or a second operational node (e.g., after the second operational node uses a second entangled qubit set to transfer a quantum state based on a dataset to a first entangled qubit set at the first operational node). Based on receiving the qubit refresh request, central node 404 may send a third entangled qubit set to the first operational node and may send a fourth entangled qubit set to the second operational node, wherein the third entangled qubit set is entangled with the fourth entangled qubit set.

In some examples where entanglement unit 418 generates entangled qubits on-demand, entanglement unit 418 may generate the entangled qubits in response to a data request. For example, entanglement unit 418 may be configured to obtain a data request that indicates that the first operational node needs a second dataset to finish an operation that involves generating the joined dataset based on the first dataset and the second data. Central node 404 may also send the data load request to the second operational node in response to the data request. In this example, entanglement unit 418 may be configured to generate the first entangled qubit set and the second entangled qubit set in response to the data request. Entanglement unit 418 may send the first entangled qubit set to the first operational node and the second entangled qubit set to the second operational node.

After the operation of FIG. 7 starts, entanglement unit 418 may generate entangled sets of qubits based on the number of operational nodes 410 in distributed computing system 400. Thus, in the example of FIG. 7, entanglement unit 418 may generate qubit sets for N operational nodes 410 of distributed computing system 400 (702). In other words, distributed computing system 400 may generate at least one entangled set of qubits for each node of a plurality of quantum nodes of distributed computing system 400. For example, entanglement unit 418 may generate the at least one entangled set of qubits for each quantum node of the plurality of nodes in accordance with a predetermined schedule. Additionally or alternatively, entanglement unit 418 may generate the at least one entangled set of qubits for each node of the plurality of quantum nodes in response to a request from one or more nodes of the plurality of nodes for additional qubits.

As part of the process of generating the qubit sets for the N operational nodes 410 of distributed computing system 400, entanglement unit 418 may, for N operational nodes 410, generate N(N−1) sets of entangled qubits (704). Thus, in some examples, entanglement unit 418 may generate a number of entangled sets of qubits for N operational nodes 410 based on the following formula:

$$\frac{N !}{( N - r ) !}$$

where N represents the number of operational nodes 410, and r represents the number of qubits in an entangled set of qubits. Thus, in examples where r is equal to 2 (i.e., the entangled set of qubits includes 2 qubits), entanglement unit 418 may generate N*(N−1) entangled sets of qubits for N nodes. However, it should be understood that the formula provided above is merely an example and that other numbers of entangled sets of qubits, other numbers of qubits per entangled qubit set, and other formulas for generating the number of entangled sets of qubits are contemplated.

Furthermore, in the example of FIG. 7, central node 404 (i.e., QCentral System) may store a mapping of qubit sets (e.g., qubit set mapping 610) to operational nodes 410 where the qubit sets are mapped in the Qubit Set Mapping Repository (706). In other words, entanglement unit 418 may generate data that map identifiers of entangled qubit sets to one another. The map may also indicate which quantum nodes are to receive the entangled qubit sets. Entanglement unit 418 may store the mapping between entangled qubit sets (710) to qubit set mapping 610. Additionally, in the example of FIG. 7, entanglement unit 418 may return the qubit sets and the qubit set mapping (708). For each quantum node (denoted quantum node X), entanglement unit 418 may send the entangled qubit sets mapped to quantum node X to quantum node X (712).

Thus, distributed computing system 400 may map entanglements between each of the entangled sets of qubits. In this way, distributed computing system 400 may track the entangled sets of qubits when they are located at the respective quantum nodes associated with the plurality of nodes of distributed computing system 400. The mapping may indicate the relationships between the entanglements to facilitate the performance of computational tasks. Distributed computing system 400 may store the mapping of the entanglements in a repository (e.g., qubit set mapping 610). In some examples, central node 404 may be configured to store the mapping of the entanglements in the repository.

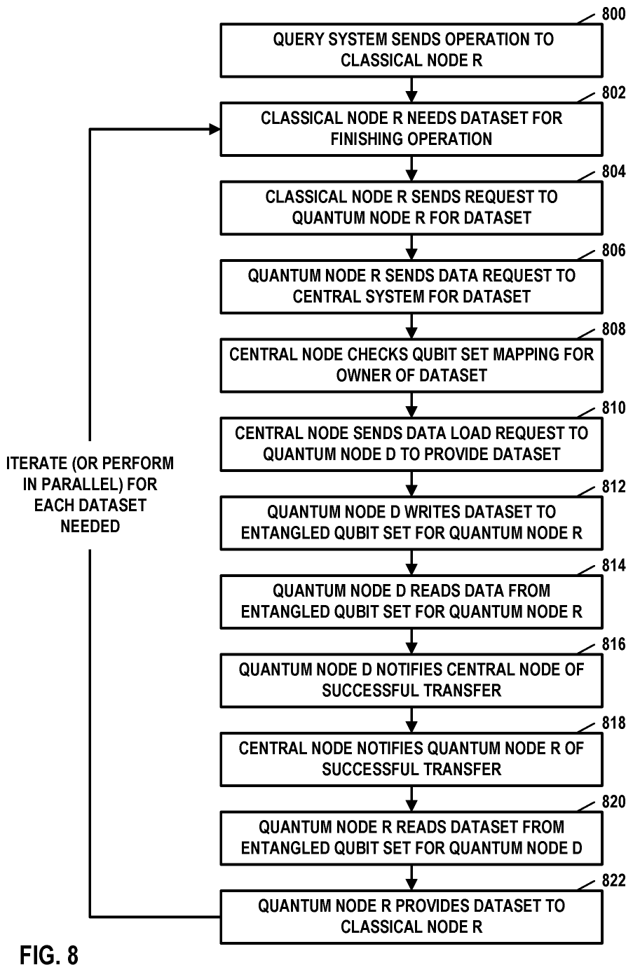

FIG. 8 is a flowchart of an example operation for moving dataset between operational nodes of the computing system in accordance with one or more techniques of this disclosure. In the example of FIG. 8, query system 406 may send an operation to classical node R, i.e., a receiving classical node (800). In other words, query system 406 instructs classical node R to perform an operation as part of distributed computing system 400 executing a query. Furthermore, in the example of FIG. 8, classical node R may determine that classical node R needs a dataset for finishing the operation (802). For example, the operation may involve joining dataset A and dataset B over criterion C to generate a joined dataset. In this example, classical node R may determine that the storage devices of classical node R do not store dataset B. Hence, classical node R may determine that dataset B is needed to finish the operation received from query system 406.

Accordingly, classical node R may send a request to quantum node R, i.e., the receiving quantum node, for the dataset (804). The receiving quantum node may also be denoted as QFramework R. Based on the request, quantum node R may send a data request to central node 404 (i.e., QCentral System) for the dataset (806). Quantum node R may send the data request to central node 404 via a classical communication channel.

Based on the data request, central node 404 (e.g., search unit 420 of central node 404) may check qubit set mapping 610 for an owner of the dataset (808). The owner of the dataset is an operational node at which the dataset is stored. As discussed above, qubit set mapping 610 may include data that map identifiers of qubit sets to operational nodes. For example, an operational node D (where D denotes “deliverer”) may store the dataset. In this example, central node 404 may use qubit set mapping 610 to determine an identifier of a qubit set of the quantum node of operational node D (i.e., quantum node D) that is entangled with a qubit set of quantum node R. Central node 404 may also use qubit set mapping 610 to determine an identifier of a qubit set of the quantum node of quantum node R that is entangled with the qubit set of quantum node R. Determining identifiers of qubit sets may be especially significant when distributed computing system 400 includes more than two operational nodes. For ease of explanation, this disclosure may refer to the qubit set of quantum node R that is entangled with the qubit set of quantum node D as entangled qubit set R (e.g., a first entangled qubit set) and entangled qubit set D (e.g., a second entangled qubit set).

Furthermore, in the example of FIG. 8, central node 404 may send a data load request to quantum node D to provide the dataset (810). The data load request may instruct quantum node D to use entangled qubit set D to transfer a quantum state based on the dataset to the first entangled qubit set. Central node 404 may send the data load request to quantum node D via a classical communication channel.

Based on obtaining the data load request, quantum node D may write the dataset to the entangled qubit set for quantum node R (i.e., entangled qubit set R). For example, quantum node R may load the dataset into a staging qubit set, resulting in each qubit i of the staging qubit set having a quantum state |ψᵢ [symbol] . In this example, quantum node R has an entangled qubit set R that is entangled with an entangled qubit set D at second quantum node D. Entangled qubit set D is distinct from the staging qubit set. There may be equal numbers of qubits in entangled qubit set D and the staging qubit set. For each qubit i of the staging qubit set, quantum node D modifies a corresponding entangled qubit of entangled qubit set D based on the quantum state |ψᵢ [symbol] of qubit i. For example, for each qubit of the staging qubit set, quantum node D may pass the quantum state |ψᵢ [symbol] and a quantum state of the corresponding qubit of entangled qubit set D through a controlled-NOT (CNOT) gate.

Quantum node D may then read data from the entangled qubit set for quantum node R (814). For instance, continuing the example of the previous paragraph, quantum node D may measure the quantum state |ψᵢ [symbol] of qubit i and the quantum state of the corresponding qubit of entangled qubit set D (entangled qubit set D being the entangled qubit set at quantum node D for quantum node R). Amplitude amplification is one example technique for reading encoded data.

Quantum node D may then notify central node 404 of a successful transfer (816). In other words, quantum node D may transmit a transfer notification via a classical communication channel to central node 404. In the example of FIG. 8, quantum node D sends the transfer notification to central node 404 (e.g., teleportation unit 416 of central node 404). Central node 404 (e.g., teleportation unit 416 of central node 404) may then notify quantum node R of the successful transfer (818). In other words, central node 404 may forward the transfer notification to quantum node R. In other examples, quantum node D may send the transfer notification directly to quantum node R. In some examples, the transfer notification may include the identifier of an entangled qubit set at quantum node R that was identified by search unit 420 as being entangled with entangled qubit set D.

In some examples, for each qubit i of the staging qubit set, the transfer notification may include a classical bit (xᵢ) indicating the result of measuring the qubit i of the staging qubit set and a classical bit (zᵢ) indicating the result of measuring the entangled qubit corresponding to qubit i. Thus, there the transfer notification may include two classical bits for each qubit of the staging qubit set.

Based on receiving the transfer notification, quantum node R may modify qubits of the entangled qubit R based on the classical bits in the transfer notification. For example, for each qubit i of the entangled qubit set R, the quantum node R may perform a first modification operation. The first modification operation applies a Pauli X gate to the quantum state of qubit i of the first entangled qubit set if the classical bit xᵢ of the transfer notification is equal to 1. The first modification operation does not change the quantum state of qubit i of the first entangled qubit set if the classical bit xᵢ of the transfer notification is not equal to 1. Quantum node R may then apply a second modification operation on the quantum state of qubit i following the first modification operation. The second modification operation may apply a Pauli Z gate to the quantum state of qubit i if the classical bit zᵢ is equal to 1. Otherwise, the second modification operation does not change the quantum state of qubit i. After applying the second modification operation, the quantum state of qubit i is the same as the quantum state of the corresponding qubit i in the staging qubit set (i.e., |ψᵢ [symbol] ).

As discussed above, the process of loading the second dataset into the staging qubit set may involve generating a superposition of the quantum states of each of the qubits of the staging qubit set. Thus, in some examples, where the second quantum set loads the dataset into the staging qubit set using amplitude encoding, the amplitudes of waveforms of the qubits of the staging qubit set are based on the dataset as a whole. Thus, the amplitude of the waveform of an individual qubit of the staging qubit set does not correspond merely to a single classical bit of the second dataset. Thus, it is this more complex quantum state of the set of qubits that is transferred to the first entangled qubit set through quantum teleportation. The amount of data now represented by the first entangled qubit set may be considerably greater than the amount of data contained in the transfer notification. For example, if the goal is for the first quantum node to perform Grover's algorithm to find applicable entries as part of performing a join operation, and there are 10,000,000,000 data items in the second dataset, the staging qubit set (and the first and second entangled qubit sets) may each include 34 qubits. Thus, because the transfer notification includes two classical bits for each qubit of the staging qubit set, the transfer notification may only need to contain 68 classical bits (2*34 qubits). Hence, far less classical data may need to be sent between the operational node D and operational node R than if operational node D were to send the dataset to operational node R via a classical communication channel. The no-cloning theorem is maintained because the quantum state at quantum node D is destroyed by quantum node D when measuring the quantum states of the staging qubit set and entangled qubit set D.

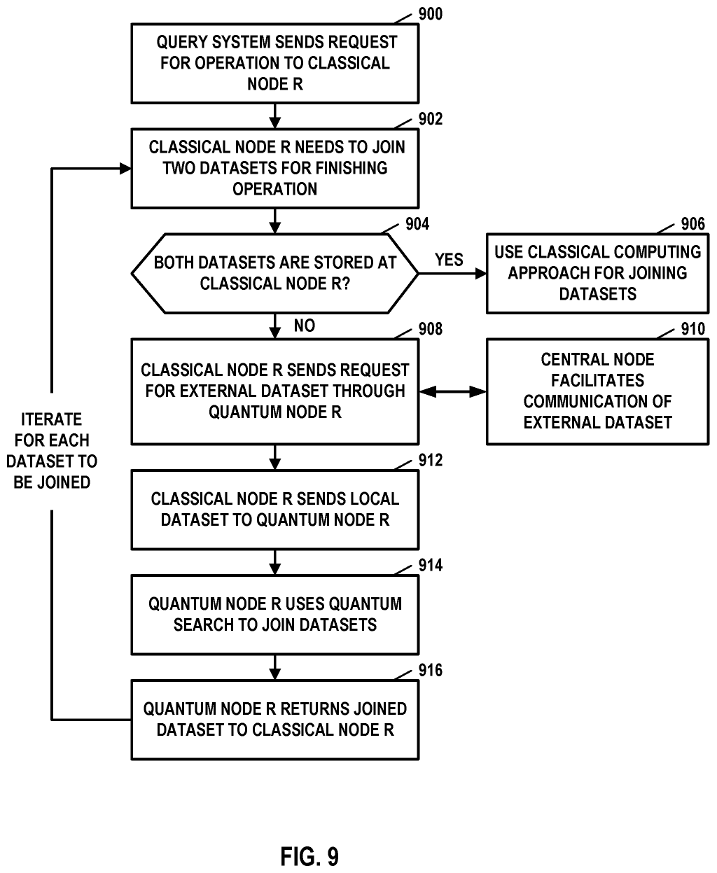

Operational node R may perform various actions after operational node R receives an indication of successful transfer. For instance, in this example of FIG. 8, quantum node R may read the dataset from the entangled qubit set for quantum node D (i.e., entangled qubit set R) (820). For example, quantum node R may take one or more measurements (e.g., Bell measurements) of the qubits of entangled qubit set R. Quantum node R may then provide the dataset to classical node R (822). For example, classical node R may receive the dataset from quantum node R and store the dataset to one or more classical storage devices. Furthermore, in the example of FIG. 8, distributed computing system 400 may iterate through the actions of FIG. 8 (or perform the actions of FIG. 8 multiple times in parallel) so that operational node R has each dataset needed to finish the operation that query system 406 sent to operational node R. In other examples, such as the example described below with respect to FIG. 9, quantum node R uses entangled qubit set D without measuring the qubits of entangled qubit set D.

Thus, to summarize the example operation of FIG. 8, distributed computing system 400 may send, by a first node of the distributed system or via another device, a request for a dataset to a QCentral system of the distributed system. In some examples, the distributed system may send the request to enable an operation requested by the query layer. The QCentral system may send the request for the dataset to a second node, where the dataset is stored at the second node. The QFramework associated with the second node may execute a quantum algorithm to transform a state of an entangled set of qubits at the second node. Transformation of the state of the entangled set of qubits at the QFramework associated with the second node may effectuate a corresponding transformation of an entangled set of qubits at the QFramework associated with the first node that provides an indication of the dataset. The QFramework associated with the first node may then process the transformed entangled set of qubits at the first node to obtain the dataset. In some examples, the second node (or the QFramework associated therewith) may send a completion signal (i.e., a transfer notification) to the QCentral system in response to completion of the execution of the quantum algorithm by the QFramework associated with the second node. Furthermore, in such examples, The QCentral system may send a read signal (i.e., a second transfer notification) to the first node (or the QFramework associated therewith) in response to receipt of the completion signal by the quantum central system. The QFramework associated with the first node first node may process the transformed entangled set of qubits at the first node to obtain the dataset in response to receipt of the read signal by the first node.

FIG. 9 is a flowchart of an example operation for joining datasets by the distributed computing system in accordance with one or more techniques of this disclosure. In the example of FIG. 9, query system 406 may send a request for an operation to classical node R (900). Classical node R may be one of classical nodes 412. The operation may be all or part of a process to execute a query. For instance, in the example of FIG. 9, classical node R may determine that classical node R needs to join two datasets in order to finish the operation (902). Classical node R may determine that classical node R needs to join the two datasets based on the query including a statement to joint the two datasets. Additionally, classical node R may determine whether both of the two datasets are stored at classical node R (904). For instance, classical node R may use an index to determine the locations of datasets. In the example of FIG. 9, based on classical node R determining that both datasets are stored at classical node R (“YES” branch of 904), classical node R may use a classical computing approach for joining the two datasets (906). For example, classical node R may use a searching algorithm (e.g., brute force search, index-based search, tree-based search, etc.) to identify items in the datasets that may form the basis of items in the joined dataset.

On the other hand, based on a determination that one of the datasets (i.e., an external dataset) is not stored at classical node R (“NO” branch of 904), classical node R may send a request for the external dataset through quantum node R (i.e., a QFramework) (908). Central node 404 may then facilitate communication of the external dataset, e.g., using an operation such as the operation of FIG. 8 (910). In other words, a quantum state based on the external dataset may be transferred to a qubit set at quantum node R.

Furthermore, in the example of FIG. 9, classical node R may send the dataset stored at classical node R (i.e., a local dataset) to quantum node R (912). For example, classical node R may read the local dataset from one or more classical data storage devices and quantum node R may load the local dataset into a qubit set (which may be referred to herein as temporal qubits).

Quantum node R may then use a quantum search to join the datasets (914). As part of joining the datasets, quantum node R may perform quantum search over the two datasets. For example, each of the datasets may include entries that have identifiers, denoted key_id. In this example, for each key_id of the local dataset, quantum node R may search for an entry in the external dataset having a key_id equal to the of the local dataset. In this example, for each entry in the external dataset located in the search, quantum node may join the entry of the local dataset having key_id and the entry in the external dataset. Quantum node R may then return the joined dataset to classical node R (916). Classical node R may write the joined dataset to one or more classical data storage devices, send the joined dataset to query system 406, or perform one or more other actions. In other words, classical node R may perform remaining operations over the joined dataset. Furthermore, in the example of FIG. 9, operational node R may iterate through the actions of FIG. 9 for each dataset to be joined.

Thus, to summarize FIG. 9, when the two or more datasets are stored at the same node, a classical approach or a quantum approach in accordance with techniques of this disclosure may be used. However, a quantum approach may be particularly useful when the two or more datasets are not stored at the same node. In such cases, a first node of distributed computing system 400 may initiate a process to join a first dataset with a second dataset, where the first dataset is stored at the first node, and where the second dataset is stored at a second node of distributed computing system 400. In some examples, the first dataset and/or the second dataset may be structured. That is, the first dataset and/or the second dataset may not be indexed. The QFramework associated with the first node may process (following completion of execution of the quantum algorithm to effectuate a corresponding transformation of the entangled set of qubits at the QFramework associated with the first node) an entangled set of qubits at the QFramework associated with the first node to obtain the second dataset from the second node. The QFramework associated with the first node may then join the first dataset with the second dataset by searching for identifying information in the first dataset that corresponds with identifying information in the second dataset. In some examples, the QFramework associated with the first node may search for identifying information in the first dataset that corresponds with identifying information in the second dataset by performing Grover's algorithm. Usage of Grover's algorithm may yield similar or superior search speeds compared to searching based on classical computing. This advantage may be present even when the datasets being joined by the system are unstructured (e.g., no indexes are used). Although the datasets may not be indexed, it should be noted that the datasets may still contain identifying information to facilitate searching.

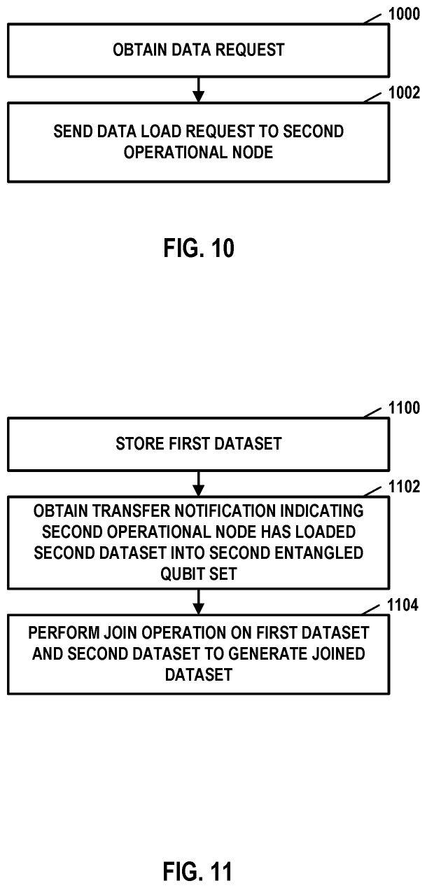

FIG. 10 is a flowchart illustrating an example operation of central node 404 of distributed computing system 400 in accordance with one or more techniques of this disclosure. In the example of FIG. 10, central node 404 may obtain a data request (1000). A first operational node of distributed computing system 400 stores a first dataset. The data request may indicate that the first operational node needs a second dataset to finish an operation that involves generating a joined dataset based on the first dataset and the second data. Central node 404 may receive the data request from the first operational node (e.g., a classical node or quantum node of the first operational node), from query system 406, or from another source.

Based on the data request, central node 404 may send a data load request to a second operational node of the plurality of operational nodes (1002). The second operational node stores the second dataset. In some examples, central node 404 may determine that the second operational node stores the second dataset. In other examples, the first operational node may determine that the second operational node stores the second dataset.

Additionally, a first entangled qubit set at the first operational node includes qubits that are entangled with qubits in a second entangled qubit set at the second operational node. The data load request instructs the second operational node to use the second entangled qubit set to transfer a quantum state based on the second dataset to the first entangled qubit set. In some examples, in response to obtaining the data request, central node 404 may determine that the first entangled qubit set is entangled with the second entangled qubit set. Central node 404 may send an identifier of the second entangled qubit set to the second operational node.

After the quantum state is transferred to the first entangled qubit set, the first operational node may measure the first entangled qubit set to obtain the first dataset and may perform the join operation on the first dataset and the second dataset. In some examples, after the quantum state of the staging qubit set is transferred to the first entangled qubit set, the first operational node may perform a quantum search operation to identify data in the first dataset.

In some examples, central node 404 may subsequently obtain a first transfer notification indicating that the transfer of the quantum state is complete for the second operational node. Based on obtaining the first transfer notification, the central node may send a second transfer notification to the first operational node. The second transfer notification may indicate that the transfer of the quantum state is complete for the second operational node. In some examples, the first transfer notification includes first measurements and second measurements. The first measurements are measurements of qubits of a staging qubit set that stores the quantum state based on the second dataset. The second measurements of qubits of the second entangled qubit set after application of a controlled-NOT (CNOT) gate to the quantum state of the staging qubit set and the second entangled qubit set. The second transfer notification may include the first measurements and the second measurements.

FIG. 11 is a flowchart illustrating an example operation of an operational node of the distributed computing system in accordance with one or more techniques of this disclosure. In the example operation of FIG. 11, a first operational node of distributed computing system 400 may store a first dataset (1100). Furthermore, the first operational node has a first entangled qubit set. The first operational node may receive the first entangled qubit set from central node 404 of distributed computing system 400 that also sends the second entangled qubit set to the second operational node. For instance, the first operational node may receive the first entangled qubit set via a fiber optic communication channel connecting the central node and the first operational node.

As part of distributed computing system 400 executing a query on a distributed database stored at the plurality of operational nodes 410, the first operational node may obtain a transfer notification indicating that a second operational node of distributed computing system 400 has loaded a second dataset into a second entangled qubit set (1102). The second entangled qubit set includes qubits that are entangled with qubits of the first entangled qubit set. Loading the second dataset into the second entangled qubit set may involve loading the second dataset into a staging qubit set, passing a quantum state of the staging qubit set and a quantum state of the second entangled qubit set through a CNOT gate to modify the quantum state of the second entangled qubit set, and measuring the quantum states of the staging qubit set and the second entangled qubit set. The first operational node may obtain the transfer notification from central node 404 or directly from the second operational node.

In some examples, the first operational node may receive the query from a query system of distributed computing system 400. The first operational node may determine that execution of the query requires performing the join operation on the first dataset and the second dataset. The first operational node may then send the data request to central node 404 of distributed computing system 400. The data request may request the second dataset.

After obtaining the transfer notification, the first operational node may perform a join operation on the first dataset and the second dataset to generate a joined dataset (1104). For example, as part of performing the join operation on the first dataset and the second dataset, the first operational node may load the second dataset into a classical storage system (e.g., storage devices 510 of FIG. 5), e.g., using quantum teleportation. Additionally, in this example, the first operational node may load the first dataset from the classical storage system into a third qubit set. The first operational node may then apply a quantum search algorithm, e.g., Grover's algorithm, to the third qubit set to identify elements of the second dataset to join with elements of the first dataset to generate the joined dataset. In some examples, the first operational node may store the second dataset into a quantum random access memory (Q-RAM) system and use the Q-RAM system while performing the quantum search algorithm identify elements of the second dataset to join with elements of the first dataset.

Various aspects of the techniques may enable the following examples.

Example 1A: A method includes generating at least one entangled set of qubits for each node of a plurality of nodes of a distributed quantum computing system; mapping entanglements between each of the entangled sets of qubits; and storing the mapping of the entanglements in a repository of the distributed quantum computing system.

Example 2A: The method of example 1A, wherein the distributed quantum computing system includes a quantum central system configured to: generate the at least one entangled set of qubits for each node of the plurality of nodes; and store the mapping of the entanglements in the repository.

Example 3A: The method of example 1A or 2A, wherein generating the at least one entangled set of qubits for each node of the plurality of nodes occurs in accordance with a predetermined schedule.

Example 4A: The method of any of examples 1A to 3A, wherein generating the at least one entangled set of qubits for each node of the plurality of nodes occurs in response to a request from one or more nodes of the plurality of nodes for additional qubits.

Example 5A: The method of any of examples 1A to 4A, wherein generating the at least one entangled set of qubits for each node of the plurality of nodes includes generating N*(N−1) entangled sets of qubits for N nodes.

Example 6A: The method of any of examples 1A to 5A, wherein each set of qubits includes at least two qubits.

Example 7A: A method includes sending, by a first node of a distributed quantum computing system, a request for a dataset to a quantum central system of the distributed quantum computing system; sending, by the quantum central system, the request for the dataset to a second node, wherein the dataset is stored at the second node; executing, by a quantum framework associated with the second node, a quantum algorithm to transform a state of an entangled set of qubits at the second node, wherein transformation of the state of the entangled set of qubits at the second node effectuates a corresponding transformation of an entangled set of qubits at the first node that provides an indication of the dataset; and processing, by a quantum framework associated with the first node, the transformed entangled set of qubits at the first node to obtain the dataset.

Example 8A: The method of example 7A, further including sending, by the second node, a completion signal to the quantum central system in response to completion of the execution of the quantum algorithm by the second node.

Example 9A: The method of example 8A, further including sending, by the quantum central system, a read signal to the first node in response to receipt of the completion signal by the quantum central system, wherein processing, by the first node, the transformed entangled set of qubits at the first node to obtain the dataset is in response to receipt of the read signal by the first node.

Example 10A: A method includes initiating, by a first node of a distributed quantum computing system, a process to join a first dataset with a second dataset, wherein the first dataset is stored at the first node, and wherein the second dataset is stored at a second node of the distributed quantum computing system; processing, by a quantum framework associated with a first node of the distributed quantum computing system, an entangled set of qubits at the first node to obtain the second dataset from the second node; and joining, by the quantum framework, the first dataset with the second dataset by searching for identifying information in the first dataset that corresponds with identifying information in the second dataset.

Example 11A: The method of example 10A, wherein joining, by the quantum framework, the first dataset with the second dataset includes performing Grover's algorithm.

Example 12A: The method of example 10A or 11A, wherein the second dataset is unstructured.

Example 13A: A computing system comprising means for performing any combination of the examples of 1A to 12A.

Example 14A: A non-transitory computer-readable storage medium encoded with instructions that, when executed by one or more processors, cause the one or more processors to perform any combination of the examples of 1A to 12A.

Example 1B: A method for executing a query on a distributed database stored at plurality of operational nodes of a distributed computing system includes obtaining, by a central node of the distributed computing system, a data request, wherein a first operational node of the distributed computing system stores a first dataset and the data request indicates that the first operational node needs a second dataset to finish an operation that involves generating a joined dataset based on the first dataset and the second data; and based on the data request, sending, by the central node, a data load request to a second operational node of the plurality of operational nodes, wherein: the second operational node stores the second dataset, a first entangled qubit set at the first operational node includes qubits that are entangled with qubits in a second entangled qubit set at the second operational node, and the data load request instructs the second operational node to use the second entangled qubit set to transfer a quantum state based on the second dataset to the first entangled qubit set.

Example 2B: The method of example 1B, wherein: obtaining, by the central node, a first transfer notification indicating that the transfer of the quantum state is complete for the second operational node; and based on obtaining the first transfer notification, sending, by the central node, a second transfer notification to the first operational node, wherein the second transfer notification indicates that the transfer of the quantum state is complete for the second operational node.

Example 3B: The method of example 2B, wherein: the first transfer notification includes first measurements and second measurements, the first measurements being measurements of qubits of a staging qubit set that stores the quantum state based on the second dataset, the second measurements being measurements of qubits of the second entangled qubit set after application of a controlled-NOT (CNOT) gate to the quantum state of the staging qubit set and the second entangled qubit set, and the second transfer notification includes the first measurements and the second measurements.

Example 4B: The method of any of examples 1B through 3B, further includes measuring, by the first operational node, the first entangled qubit set to obtain the first dataset; and performing, by the first operational node, the join operation on the first dataset and the second dataset.

Example 5B: The method of any of examples 1B through 4B, further includes performing, by the first operational node, a quantum search operation to identify data in the first dataset.

Example 6B: The method of any of examples 1B through 5B, wherein: obtaining the data request comprises, obtaining, by the central node, the data request from the first operational node; and sending the data load request to the first operational node comprises sending, by the central node, the data load request to the second operational node based on obtaining the data request from the first operational node.

Example 7B: The method of example 6B, further comprising, based on obtaining the data request from the first operational node, determining, by the central node, that the second operational node stores the second dataset.

Example 8B: The method of any of examples 1B through 7B, further includes in response to obtaining the data request, determining, by the central node, that the first entangled qubit set is entangled with the second entangled qubit set; and sending, by the central node, an identifier of the second entangled qubit set to the second operational node.

Example 9B: The method of any of examples 1B through 8B, further includes obtaining, by the central node, a qubit refresh request from the first operational node or the second operational node; and based on receiving the qubit refresh request: sending, by the central node, a third entangled qubit set to the first operational node; and sending, by the central node, a fourth entangled qubit set to the second operational node, wherein the third entangled qubit set is entangled with the fourth entangled qubit set.

Example 10B: A method includes storing, by a first operational node of a distributed computing system that includes a plurality of operational nodes, a first dataset, wherein the first operational node has a first entangled qubit set; and as part of the distributed computing system executing a query on a distributed database stored at the plurality of operational nodes: obtaining, by the first operational node, a transfer notification indicating that a second operational node of the distributed computing system has loaded a second dataset into a second entangled qubit set, wherein the second entangled qubit set includes qubits that are entangled with qubits of the first entangled qubit set; after obtaining the transfer notification, performing, by the first operational node, a join operation on the first dataset and the second dataset to generate a joined dataset.

Example 11B: The method of example 10B, wherein performing the join operation on the first dataset and the second dataset comprises: loading the first dataset from the classical storage system into a temporal qubit set; and performing a quantum search algorithm over the first dataset and second dataset stored in the temporal qubit set and the first entangled qubit set, respectively; generating the joined dataset based on results of the quantum search algorithm.

Example 12B: The method of example 11B, wherein performing the quantum search algorithm comprises applying Grover's algorithm.

Example 13B: The method of any of examples 10B through 12B, further includes receiving, by the first operational node, the query from a query system of the distributed computing system; determining, by the first operational node, that execution of the query requires performing the join operation on the first dataset and the second dataset; and sending, by the first operational node, a data request to a central node of the distributed computing system, wherein the data request requests the second dataset.

Example 14B: The method of any of examples 10B through 13B, wherein obtaining the transfer notification comprises receiving the transfer notification from a central node of the distributed computing system.

Example 15B: The method of any of examples 10B through 13B, wherein obtaining the transfer notification comprises receiving the transfer notification from the second operational node.

Example 16B: The method of any of examples 10B through 15B, further includes receiving, by first operational node, the first entangled qubit set from a central node of the distributed computing system that also sends the second entangled qubit set to the second operational node.

Example 17B: A distributed computing system includes a plurality of operational nodes configured to store a distributed database, the plurality of operational nodes including at least a first operational node and a second operational node, wherein: the first operational node comprises: one or more first storage devices configured to store a first dataset; and a first entangled qubit set, and the second operational node comprises: one or more second storage devices configured to store a second dataset; and a second entangled qubit set, wherein the second entangled qubit set includes qubits entangled with qubits of the first qubit set; and a central node includes the second operational node is configured to, based on the data load request: use the second entangled qubit set to transfer the quantum state based on the second dataset to the first entangled qubit set; and transmit a transfer notification, and the first operational node is configured to: based on obtaining the transfer notification, perform a join operation on the first dataset and the second dataset to generate a joined dataset.

Example 18B: The distributed computing system of example 17B, wherein the second operational node is configured to, as part of performing the join operation, perform a quantum search operation using the first entangled qubit set to identify data in the second dataset.

Example 19B: The distributed computing system of any of examples 17B and 18B, wherein the central node further comprises an entanglement unit configured to generate the first entangled qubit set and the second entangled qubit set, send the first entangled qubit set to the first operational node, and send the second entangled qubit set to the second operational node.

Example 20B: The distributed computing system of any of examples 17B through 19B, wherein: the central node is configured to: obtain a data request that indicates that the first operational node needs a second dataset to finish an operation that involves generating the joined dataset based on the first dataset and the second data; and send the data load request to the second operational node in response to the data request, and the distributed computing node comprises an entanglement unit configured to: generate the first entangled qubit set and the second entangled qubit set in response to the data request; and send the first entangled qubit set to the first operational node and the second entangled qubit set to the second operational node.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

In one or more examples, the functions described may be implemented in hardware, software, firmware, or any combination thereof. If implemented in software, the functions may be stored on or transmitted over a computer-readable medium as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers, processing circuitry, or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM, or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Instructions may be executed by processing circuitry (e.g., one or more processors, such as one or more DSPs, general purpose microprocessors, ASICs, FPGAs, or other equivalent integrated or discrete logic circuitry), as well as any combination of such components. Accordingly, the term “processor” or “processing circuitry” as used herein, may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A method for executing a query on a distributed database stored at plurality of operational nodes of a distributed computing system, the method comprising:
obtaining, by a central node of the distributed computing system, a data request,
wherein a first operational node of the distributed computing system stores a first dataset and the data request indicates that the first operational node needs a second dataset to finish an operation that involves generating a joined dataset based on the first dataset and the second data; and
based on the data request, sending, by the central node, a data load request to a second operational node of the plurality of operational nodes, wherein:
the second operational node stores the second dataset,
a first entangled qubit set at the first operational node includes qubits that are entangled with qubits in a second entangled qubit set at the second operational node, and
the data load request instructs the second operational node to use the second entangled qubit set to transfer a quantum state based on the second dataset to the first entangled qubit set.

2. The method of claim 1, wherein:
obtaining, by the central node, a first transfer notification indicating that the transfer of the quantum state is complete for the second operational node; and
based on obtaining the first transfer notification, sending, by the central node, a second transfer notification to the first operational node, wherein the second transfer notification indicates that the transfer of the quantum state is complete for the second operational node.

3. The method of claim 2, wherein:
the first transfer notification includes first measurements and second measurements, the first measurements being measurements of qubits of a staging qubit set that stores the quantum state based on the second dataset, the second measurements being measurements of qubits of the second entangled qubit set after application of a controlled-NOT (CNOT) gate to the quantum state of the staging qubit set and the second entangled qubit set, and
the second transfer notification includes the first measurements and the second measurements.

4. The method of claim 1, further comprising, after the quantum state is transferred to the first entangled qubit set:
measuring, by the first operational node, the first entangled qubit set to obtain the first dataset; and
performing, by the first operational node, a join operation on the first dataset and the second dataset.

5. The method of claim 1, further comprising, after the quantum state of the staging qubit set is transferred to the first entangled qubit set:
performing, by the first operational node, a quantum search operation to identify data in the first dataset.

6. The method of claim 1, wherein:
obtaining the data request comprises, obtaining, by the central node, the data request from the first operational node; and
sending the data load request to the first operational node comprises sending, by the central node, the data load request to the second operational node based on obtaining the data request from the first operational node.

7. The method of claim 6, further comprising, based on obtaining the data request from the first operational node, determining, by the central node, that the second operational node stores the second dataset.

8. The method of claim 1, further comprising:
in response to obtaining the data request, determining, by the central node, that the first entangled qubit set is entangled with the second entangled qubit set; and
sending, by the central node, an identifier of the second entangled qubit set to the second operational node.

9. The method of claim 1, further comprising:
obtaining, by the central node, a qubit refresh request from the first operational node or the second operational node; and
based on receiving the qubit refresh request:
sending, by the central node, a third entangled qubit set to the first operational node; and
sending, by the central node, a fourth entangled qubit set to the second operational node, wherein the third entangled qubit set is entangled with the fourth entangled qubit set.

10. A method comprising:
storing, by a first operational node of a distributed computing system that includes a plurality of operational nodes, a first dataset, wherein the first operational node has a first entangled qubit set; and
as part of the distributed computing system executing a query on a distributed database stored at the plurality of operational nodes:
obtaining, by the first operational node, a transfer notification indicating that a second operational node of the distributed computing system has loaded a second dataset into a second entangled qubit set, wherein the second entangled qubit set includes qubits that are entangled with qubits of the first entangled qubit set;
after obtaining the transfer notification, performing, by the first operational node, a join operation on the first dataset and the second dataset to generate a joined dataset.

11. The method of claim 10, wherein performing the join operation on the first dataset and the second dataset comprises:
loading the first dataset from a classical storage system into a temporal qubit set; and
performing a quantum search algorithm over the first dataset and the second dataset stored in the temporal qubit set and the first entangled qubit set, respectively;
generating the joined dataset based on results of the quantum search algorithm.

12. The method of claim 11, wherein performing the quantum search algorithm comprises applying Grover's algorithm.

13. The method of claim 10, further comprising:
receiving, by the first operational node, the query from a query system of the distributed computing system;
determining, by the first operational node, that execution of the query requires performing the join operation on the first dataset and the second dataset; and
sending, by the first operational node, a data request to a central node of the distributed computing system, wherein the data request requests the second dataset.

14. The method of claim 10, wherein obtaining the transfer notification comprises receiving the transfer notification from a central node of the distributed computing system.

15. The method of claim 10, wherein obtaining the transfer notification comprises receiving the transfer notification from the second operational node.

16. The method of claim 10, further comprising:
receiving, by first operational node, the first entangled qubit set from a central node of the distributed computing system that also sends the second entangled qubit set to the second operational node.

17. A distributed computing system comprising:
a plurality of operational nodes configured to store a distributed database, the plurality of operational nodes including at least a first operational node and a second operational node, wherein:
the first operational node comprises:
one or more first storage devices configured to store a first dataset; and
a first entangled qubit set, and
the second operational node comprises:
one or more second storage devices configured to store a second dataset; and
a second entangled qubit set, wherein the second entangled qubit set includes qubits entangled with qubits of the first qubit set; and
a central node comprising one or more processors implemented in circuitry, the one or more processors of the central node configured to send a data load request to the second operational node, the data load request instructs the second operational node to use the second entangled qubit set to transfer a quantum state based on the second dataset to the first entangled qubit set, wherein:
the second operational node is configured to, based on the data load request:
use the second entangled qubit set to transfer the quantum state based on the second dataset to the first entangled qubit set; and
transmit a transfer notification, and
the first operational node is configured to:
based on obtaining the transfer notification, perform a join operation on the first dataset and the second dataset to generate a joined dataset.

18. The distributed computing system of claim 17, wherein the second operational node is configured to, as part of performing the join operation, perform a quantum search operation using the first entangled qubit set to identify data in the second dataset.

19. The distributed computing system of claim 17, wherein the central node further comprises an entanglement unit configured to generate the first entangled qubit set and the second entangled qubit set, send the first entangled qubit set to the first operational node, and send the second entangled qubit set to the second operational node.

20. The distributed computing system of claim 17, wherein:
the central node is configured to:
obtain a data request that indicates that the first operational node needs the second dataset to finish an operation that involves generating the joined dataset based on the first dataset and the second data; and
send the data load request to the second operational node in response to the data request, and
the distributed computing node comprises an entanglement unit configured to:
generate the first entangled qubit set and the second entangled qubit set in response to the data request; and
send the first entangled qubit set to the first operational node and the second entangled qubit set to the second operational node.
